(19) United States
(12) Patent Application Publication
(10) Pub. No.: US 2013/0170940 A1
(43) Pub. Date: Jul. 4, 2013

(54) TREE ROPER DEVICE AND METHOD

(71) Applicant: William J. Nelson, II, Solon, OH (US)

(72) Inventor: William J. Nelson, II, Solon, OH (US)

(21) Appl. No.: 13/713,718

(22) Filed: Dec. 13, 2012

Related U.S. Application Data
(60) Provisional application No. 61/581,319, filed on Dec. 29, 2011.

(51) Int. Cl. B25J 1/04

(52) U.S. Cl. CPC B25J 1/04
USPC 414/800; 294/210

(57) ABSTRACT

The present disclosure to a tree roper device for placement of a line about a designated portion of a tree. The tree roper device includes an elongated pole assembly having a first end and a second end. At least one pole bracket is configured to attach to the tree and operably connected to the elongated pole assembly such that the elongated pole assembly is movable relative to the tree. A rest bar is attached to the elongated pole assembly adjacent the second end thereof and a line having a line length with a first, proximal end and a second, distal end is operably attached to a weight. The line is selectively supported on the rest bar such that movement of the elongated pole assembly positions the line and the weight in a predetermined position relative to the tree.

### BACKGROUND

The present exemplary embodiment relates to a tree roper device, system and method that are employed to secure a line, rope or cord over a limb on an elevated portion of a tree. It finds particular application in conjunction with looping a tension line over a tree limb to assist with tree felling, pruning or decoration, and will be described with particular reference thereto. However, it is to be appreciated that the present exemplary embodiment is also amenable to other like applications.

Trees may be located in an area with obstructions such as residential buildings, fences, or other structures. At times when a tree or a portion of a tree is removed, it is desirable to direct the falling tree or limb to a position that avoids contacting these obstructions. Tree maintenance may require the application of a positioning force to manipulate the directional falling of the tree or a limb thereof. A tension line or rope can be attached to a designated portion of the tree to allow a user to urge that portion of a tree to fall or move in a certain direction. Using a tension line provides extra assurance that the tree will be felled in a desired direction. The tension line should be set high enough in the tree to provide the needed leverage or mechanical advantage from the ground. The desired function of the tension line is to tension the tree portion being felled past its center of gravity so that gravity will then bring the portion of the tree to the ground and a line will do the steering.

Placement of the tension line about the desired portion of the tree can be time consuming, inaccurate and dangerous. For example, it is possible to install the tension line by climbing the tree and manually securing the line at the required position. However, not everyone is physically capable of ascending elevated heights and tree climbing can be a significant safety hazard due to risk of falling. Additionally, it is possible to use a “throw line” or a thin, slippery cord that is used to secure a tension line. The throw line is usually a monofilament nylon or even a sash cord or string that is attached to a throw ball at one end and the tension line at the opposite end. The thrown ball is weighted and thrown over the desired branch so the user can pull the tension line into place around the branch. However, throwing and hitting the desired area of a tree is often difficult, time consuming, exhausting, frustrating and may even be dangerous. Repeated inaccurate throws are usually experienced before an accurate throw finds the desired area. Additionally, inaccurate throws can impact other portions of the tree that may become detached thereby falling to the ground or becoming a projectile. These projectiles and an inaccurately aimed throw ball can become significant safety hazards.

Further, there are devices such as winches and telescoping rods that are known to assist a user in securing placement of the tension line around a designated portion of the tree. However, these devices and systems are generally impractical and fail to accurately position the tension line about elevated height levels of the tree without undue effort by the user.

Thus, there remains a need for a device and method to accurately place a tension line about a predetermined portion of a tree that is safe, fast and efficient that does not require the assistance of a high tree climber or undue effort by the user.

### BRIEF DESCRIPTION

In one embodiment the present disclosure pertains to a tree roper device for placement of a line about a designated portion of a tree. The tree roper device includes an elongated pole assembly having a first end and a second end. At least one pole bracket is configured to attach to the tree and operably connected to the elongated pole assembly such that the elongated pole assembly is movable relative to the tree. A rest bar is attached to the elongated pole assembly adjacent the second end thereof and a line having a line length with a first, proximal end and a second, distal end is operably attached to a weight. The line is selectively supported on the rest bar such that movement of the elongated pole assembly positions the line and the weight in a predetermined position relative to the tree.

In another embodiment of the present disclosure, provided is a method of positioning a line over an elevated portion of a tree. The method includes the steps of mounting a tree roper device including at least an elongated pole assembly, a frame support assembly, and a rest bar to the tree with a plurality of brackets. A distal end of the tree roper device is lifted towards a branch of the tree. The tree roper device supports a line attached to a weight. The distal end of the tree roper device is moved over the branch to position the weight about the designated portion of the tree. The weight is lowered from an elevated position about the branch thereby looping the line over the branch.

In still another embodiment, provided is a system for assisting placement of a line about a portion of a tree with a tree roper device. The system includes an elongated pole assembly having a first end and a second end such that the first end is operative to be manipulated by an associated user to move the second end relative to the associated tree. A first pole bracket is selectively attached to the associated tree at a first height and a second pole bracket is selectively attached to the associated tree at a second height such that the second height is greater than the first height. The first and second pole brackets are generally aligned along a first axis to support the elongated pole assembly and allow the elongated pole assembly to translate and rotate about the first axis in relation to the associated tree. A rest bar is attached to the elongated pole assembly at the second end and a line is operably attached to a weight, the line is supported on the rest bar such that movement of the elongated pole assembly positions the line and the weight in a predetermined position relative to the tree.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is a perspective view of a first embodiment of a tree roper device according to the present disclosure;

FIG. 2 is an exploded perspective view of the tree roper device of FIG. 1;

FIG. 3 is a perspective view of the tree roper device of FIG. 1 when it has been attached to a tree and in the process of being extended by a user;

FIG. 4 is an enlarged perspective view of a portion of the tree roper device of FIG. 3;

FIG. 5 is a top plan view of the tree roper device of FIG. 3 illustrating multiple rotational degrees of freedom of one embodiment of a device according to the present disclosure;

FIG. 6 is a perspective view of the tree roper device of FIG. 1 as attached to an associated tree with the device being in an extended position and as it is rotated by the user;

FIG. 7 is a front view of a tree roper device according to a second embodiment of the present disclosure;

FIG. 8A is a top view of one embodiment of a pole bracket of the tree roper device of FIG. 7;

FIG. 8B is a side view of the pole bracket of the tree roper device of FIG. 7;

FIG. 9 is a front view in partial cross section of one embodiment of a T-connector of the roper device of FIG. 7;

FIG. 10 is a partial cross sectional side view of one embodiment of an extension segment of the tree roper device according to FIG. 7;

FIG. 11 is a front view of one embodiment of a rest bar of the tree roper device according to FIG. 7;

FIG. 12 is a front view in partial cross section of a second embodiment of the T-connector of the tree roper device of FIG. 7;

FIG. 13 is a partial cross sectional side view of a second embodiment of the extension segment of the tree roper device according to FIG. 7;

FIG. 14 is a front view of a second embodiment of the rest bar of the tree roper device according to FIG. 7.

### DETAILED DESCRIPTION

It is to be understood that the detailed figures are for purposes of illustrating exemplary embodiments of the present disclosure only and are not intended to be limiting. Additionally, it will be appreciated that the drawings are not to scale and that portions of certain elements may be exaggerated for the purpose of clarity and ease of illustration.

In accordance with the present disclosure, a tree roper tool is provided having an elongated pole assembly that is attached to a tree by at least a first pole bracket and a second pole bracket. A rest bar is attached to the elongated pole assembly to selectively support a tension line placed thereon. The elongated pole assembly is configured to extend the rest bar along with a portion of the tension line thereon to a desired height along the tree. The tree roper tool is configured to be selectively pivoted by a user to position the rest bar and the tension line thereon over a desired branch or other portion of the tree. The tension line can then be placed in a desired location for assistance with tree trimming, removal and decoration.

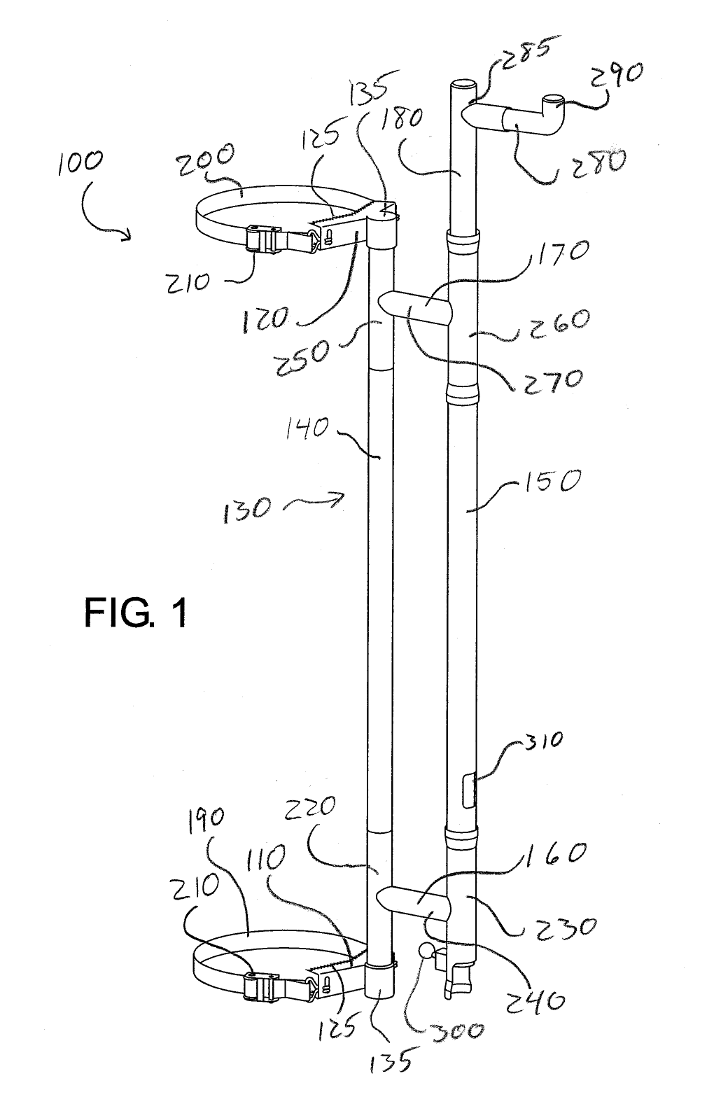

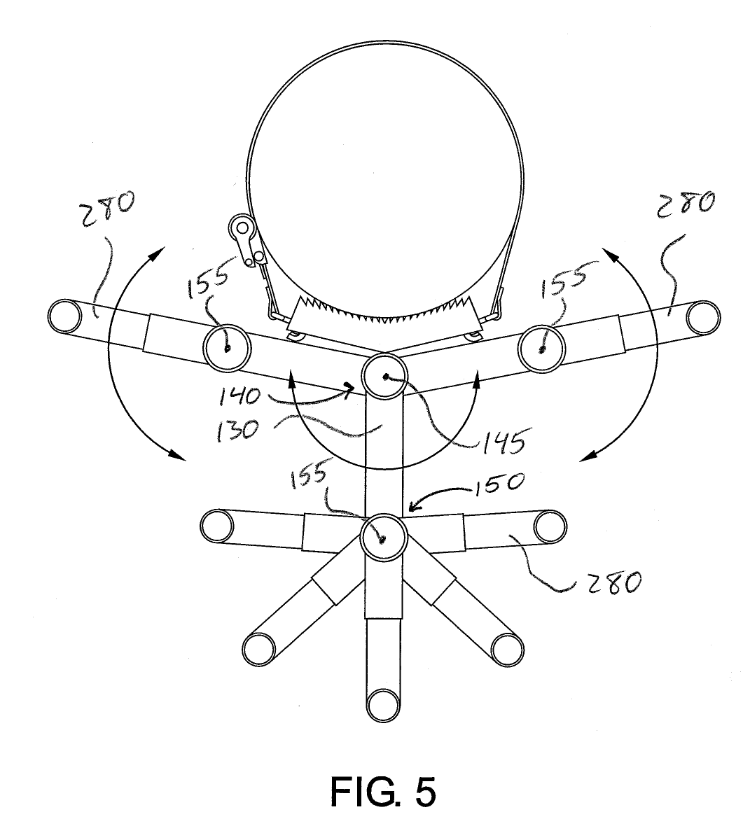

With reference to FIG. 1, a first embodiment of a tree roper tool 100 is illustrated. A first pole bracket 110 is spaced from and positioned in general alignment with a second pole bracket 120. The brackets are attached to a segmented frame support assembly 130 that includes a segmented body having a pair of elongated supports. The first elongated support or tree pole 140 is attached to a second elongated support or guide pole 150. The tree pole 140 and the guide pole 150 are connected to each other by a first H-post 160 and a second H-post 170. An elongated pole assembly 180 is supported by the guide pole 150. As illustrated in FIG. 5, the tree pole 140 is configured to be positioned adjacent to the tree along a first, generally vertical, axis 145 while the guide pole 150 is generally spaced from the tree and aligned along a second axis 155. The second axis 155 can be generally parallel to the first axis 145.

In one embodiment, the pole brackets 110, 120 include an elongated body having a generally perpendicular orientation relative to the frame support assembly 130. Each bracket 110, 120 includes a plurality of serrated teeth 125 positioned along the elongated body. The serrated teeth 125 are positioned towards the tree and are adapted to grip a surface thereof. A connection member 135 is positioned on the elongated body of the brackets opposite from the serrated teeth 125. The connection member 135 is adapted to connect each bracket 110, 120 to the frame support assembly 130 in stable alignment. The frame support assembly 130 can have a generally parallel orientation relative to a vertical axis of the tree. Additionally, the connection member 135 is rotatably attached to the frame support assembly 130 such that the frame support assembly 130 can be selectively rotated by the user along the first axis 145.

Adjustable straps 190, 200 are provided to wrap around the tree and secure the pole brackets 110, 120 to a trunk of the tree. Each strap includes a ratchet member 210 to selectively adjust the strap around the tree to position the tree roper tool 100 in secured attachment to the tree.

The first H-post 160 includes a first elongated section 220 that is spaced from and is oriented generally parallel to a first elongated guide member 230. The first section 220 and the first guide member 230 are connected by a first bridge member 240. Similarly, the second H-post 170 includes a second elongated section 250 that is spaced from and is oriented generally parallel to a second elongated guide member 260. The second section 250 and the second guide member 260 are connected by a second bridge member 270. The first and second elongated sections 220, 250 are generally aligned along the first axis 145 and are adapted to attach to the tree pole 140. The first and second elongated guide members 230, 260 are generally aligned along the second axis 155 and are adapted to attach to the guide pole 150. The first guide member 230, the guide pole 150 and the second guide member 260 have hollow bodies that are adapted to receive the elongated pole assembly 180 therein. The first guide member 230 includes a latch mechanism 300 for selective support of the elongated pole assembly 180. A window 310 can be positioned along the guide pole 150 to display the position of the elongated pole assembly 180 within the guide pole 150.

The first pole bracket 110 is rotatably attached to the first section 220 of the first H-post 160 towards the bottom of the tree roper device 100. The second pole bracket 110 is rotatably attached to the second section 250 of the second H-post 170 towards the top of the frame support assembly 130. It is desirable to position the first pole bracket 110 and the second pole bracket 120 in general alignment to allow a user to rotate the tree roper device about the first axis 145.

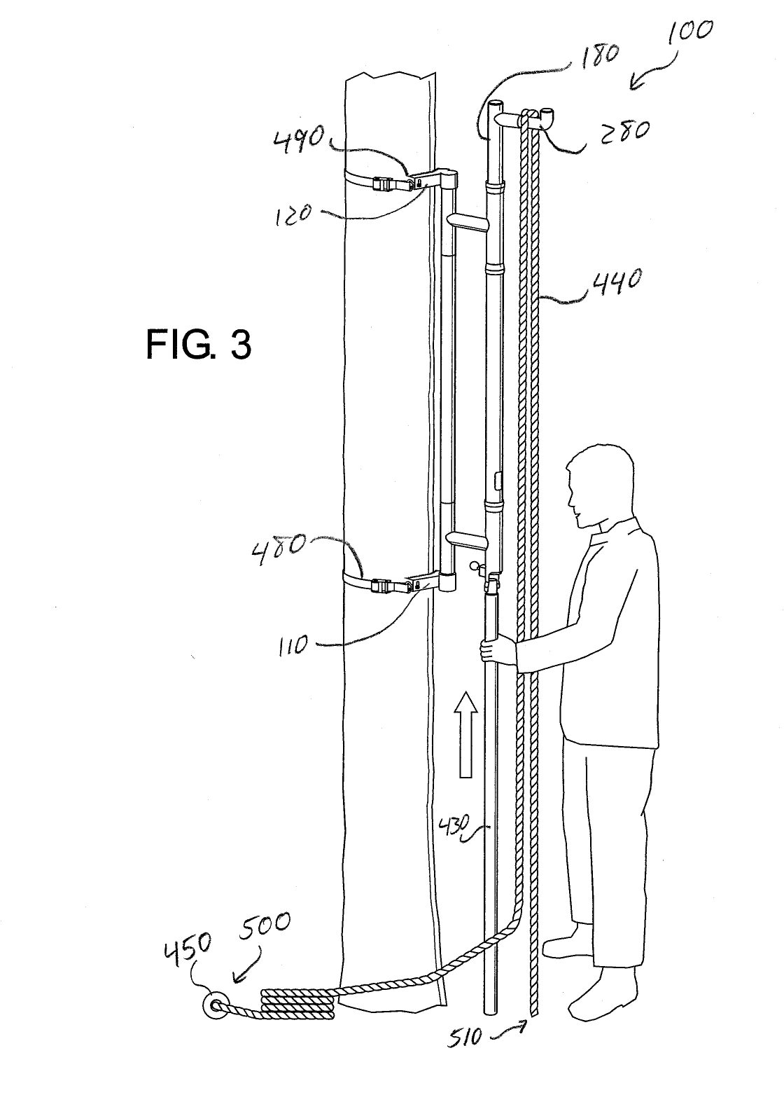

A rest bar 280 is attached to a T-connector 285 located at a top portion of the elongated pole assembly 180. The rest bar 280 extends radially from the elongated pole assembly 180 and includes an upturned distal end portion 290. The rest bar 280 is configured to selectively support a tension line 440 (see FIG. 3) such that movement of the elongated pole assembly 180 positions the tension line 440 in a predetermined position relative to the tree.

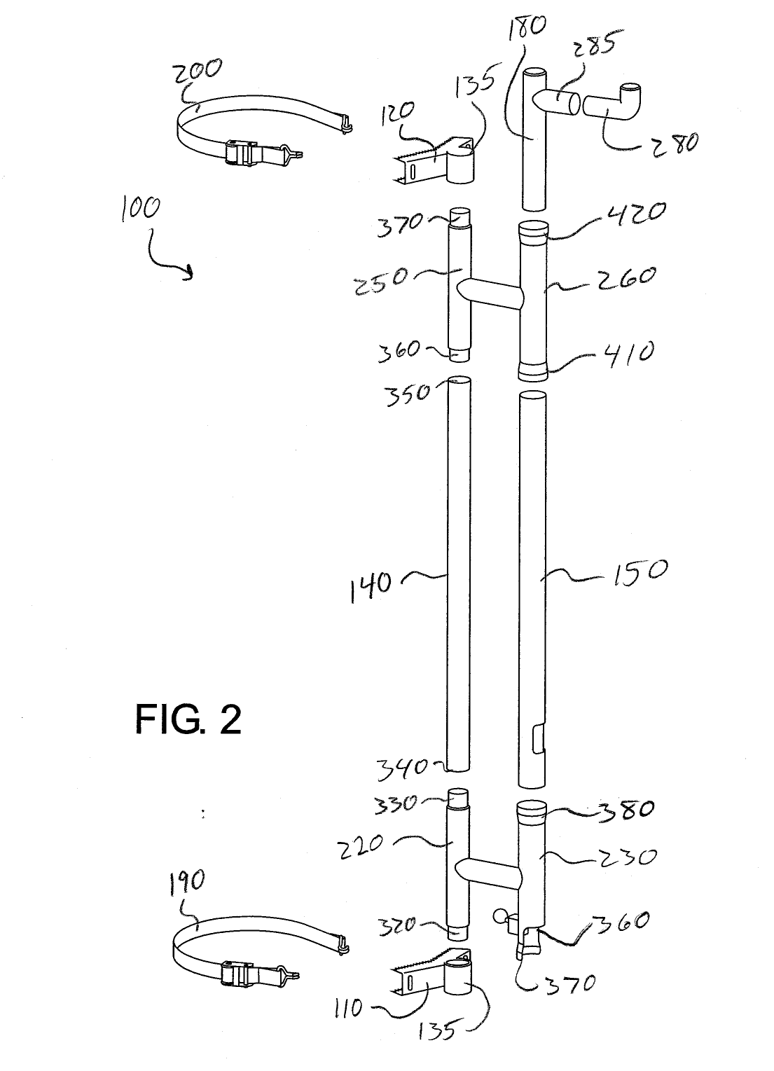

FIG. 2 discloses an exploded view of the tree roper device 100 and displays each of the elements in a segmented orientation. The first section 220 includes a bottom male end 320 disposed opposite a top male end 330. The tree pole 140 includes a first female end 340 disposed opposite a second female end 350. The second section 250 includes a bottom male end 360 located opposite a top male end 370. The bottom male end 320 of the first section 220 is inserted into the connection member 135 of the first bracket 110. The top male end 330 of the first section 220 is inserted into the first female end 340 of the tree pole 140. The bottom male end 360 of the second section 250 is inserted into the second female end 350 of the tree pole 140. The top male end 370 of the second section 250 is inserted into the connection member 135 of the second bracket 120.

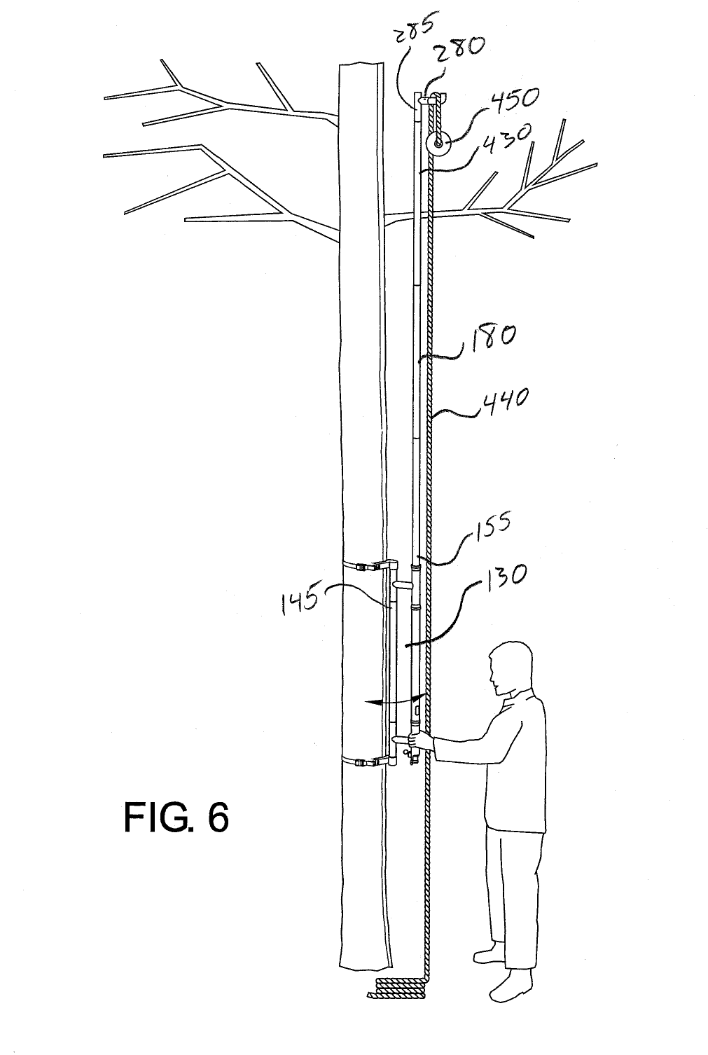

The first guide member 230 includes an open bottom 360 with a curved back wall support 370 that is configured to guide and receive each segment 430 (FIG. 3) of the elongated pole assembly 180. The first guide member 230 also includes a top female end 380. The guide pole 150 includes a bottom end 390 and an oppositely disposed top end 400. The second guide member 260 includes a bottom female end 410 and a top female end 420. The top female end 380 of the first guide member 230 receives the bottom end 390 of the guide pole 150. The bottom female end 410 of the second guide member 260 receives the top end 400 of the guide pole 150. The T-connector 285 of the elongated pole assembly 180 extends from the top female end 420 of the second guide member 260 and is attached to a segment extension 430 (see FIG. 6). These elements are disclosed to be connected by male to female type fasteners. However, other fastening configurations can also be utilized.

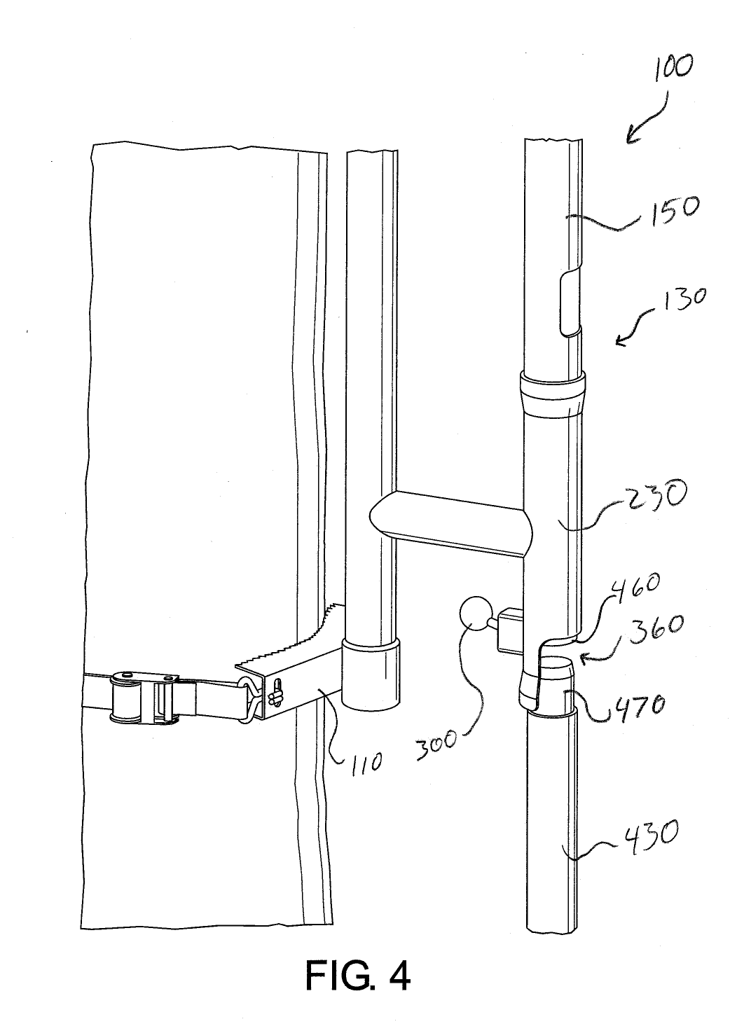

FIG. 3 illustrates the tree roper device 100 attached to the tree with a tension line 440 supported thereon. In one embodiment, a user positions the segment extension 430 within the open bottom 360 of the first guide member 230 to raise the elongated pole assembly 180 to a height equal to the height of the segment extension 430. As illustrated in FIG. 4, the segment 430 is adapted to be received by the frame support assembly 130. To this end, the segment 430 extends along the second axis 155 and engages a bottom 460 of the elongated pole assembly 180 within the guide pole 150 therein. Additional segments 430 can be added to raise the rest bar 280 towards the desired height along the tree. In one embodiment, each segment 430 includes a bottom male end 460 and a top female end 470 such that the female end 470 is adapted to connect to the male end 460. This feature allows for the stability of the rest bar 280 as it is extended to the desired height above the frame support assembly 130. A plurality of additional segments 430 may optionally be connected to each other to raise the rest bar 280 and T-connector 285 to the desired height. In one embodiment, the segment extensions are generally cylindrical and can have a length between 6″ (15.24 cm) and 40″ (101.6 cm) and a diameter between ⅛″ (0.3175 cm) to 5″ (12.7 cm). However, the length, diameter and shape of each segment extension 430 can have any desired dimension or configuration and is not limited as such. The latching mechanism 300 is adapted to engage the bottom male end 460 of each segment 430 to selectively lock the elongated pole assembly 180 in place as it is located within the first guide member 230.

In FIG. 3, the first pole bracket 110 is selectively attached to the tree at a first height 480. The second pole bracket 120 is selectively attached to the tree at a second height 490. The second height 490 is greater than the first height 480 and the first bracket 110 and second bracket 120 are aligned along the tree.

The tension line 440 can be a rope, line, cable or other flexible elongated member having a predetermined length with a distal end 500 and a proximal end 510. A weight 450 is attached to the line 440 at the distal end 500 and the line is selectively supported by the rest bar 280. Movement of the elongated pole assembly 180 positions the tension line 440 and the weight 450 attached thereto in a predetermined position relative to the tree. In one embodiment the weight 450 can be between 2 and 20 pounds (0.907 and 9.07 kilograms).

In the embodiment of FIG. 5, the tree roper device 100 includes two rotational degrees of freedom. The first axis 145 is generally aligned adjacent to the tree and provides the first rotational degree of freedom. The second axis 155 is spaced from the first axis 145 and remains generally parallel to the first axis 145. The elongated pole assembly 180 is aligned along the second axis 155 and is adapted to be selectively rotated to position the rest bar 280 and the line 440 supported thereon to the desired position relative to the tree. This provides the second degree of freedom.

FIG. 6 illustrates the tree roper device 100 with the elongated pole assembly 180 extended to the desired height. In one embodiment, the user securely attaches the tree roper device 100 to the tree. The rest bar 280 and the line 440 supported thereon is lifted towards the branch of the tree. The user manipulates the frame support assembly 130 to position the weight 450 attached to the line 440 over a branch extending from the tree. The user selectively rotates the frame support assembly 130 about the first axis 145 to position the elongated pole assembly 180 in the desired location relative to the branch. The user then rotates the elongated pole assembly 180 about the second axis 155 to position the rest bar 280 at a location above the branch thereby allowing the weight 450 attached to the line 440 to be lowered around the branch. Once the weight 450 is placed in the desired position, the user releases the line 440 to lower the weight 450 around the branch thereby looping the line 440 around a portion of the branch that is to be secured. The latching mechanism 300 is adapted to engage the bottom male end 460 of each segment 430 to selectively lock the elongated pole assembly 180 in place as it is located within the first guide member 230. The latching mechanism 300 is operable to prevent extension segments 430 from falling down or detaching from the frame support assembly 130.

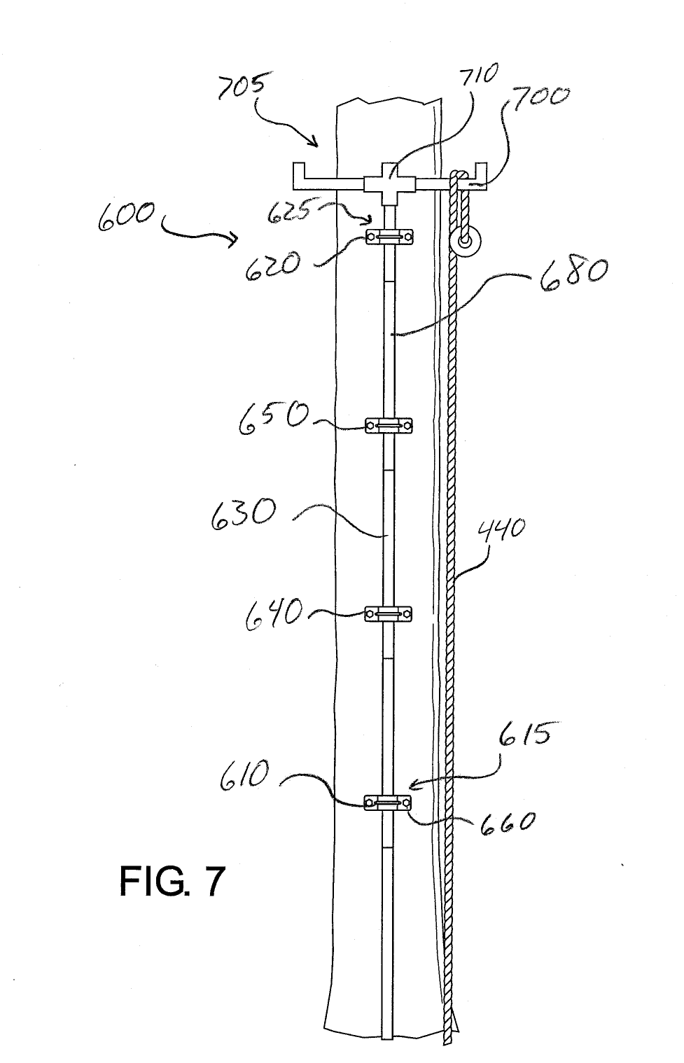

In FIG. 7, a second embodiment of a tree roper device 600 is provided. The device 600 includes an elongated pole assembly 680 having a plurality of segment extensions 630. The elongated pole assembly 680 is movably attached to the tree by a plurality of brackets. A first pole bracket 610 is attached to the tree at a first height 615 and a second pole bracket 620 is attached to the tree at a second height 625. The first bracket 610 is generally vertically aligned with the second bracket 620 along the tree. Optionally, additional brackets 640, 650 can be attached to the tree between the first height 615 and the second height 625 to provide additional support for the elongated pole assembly 680.

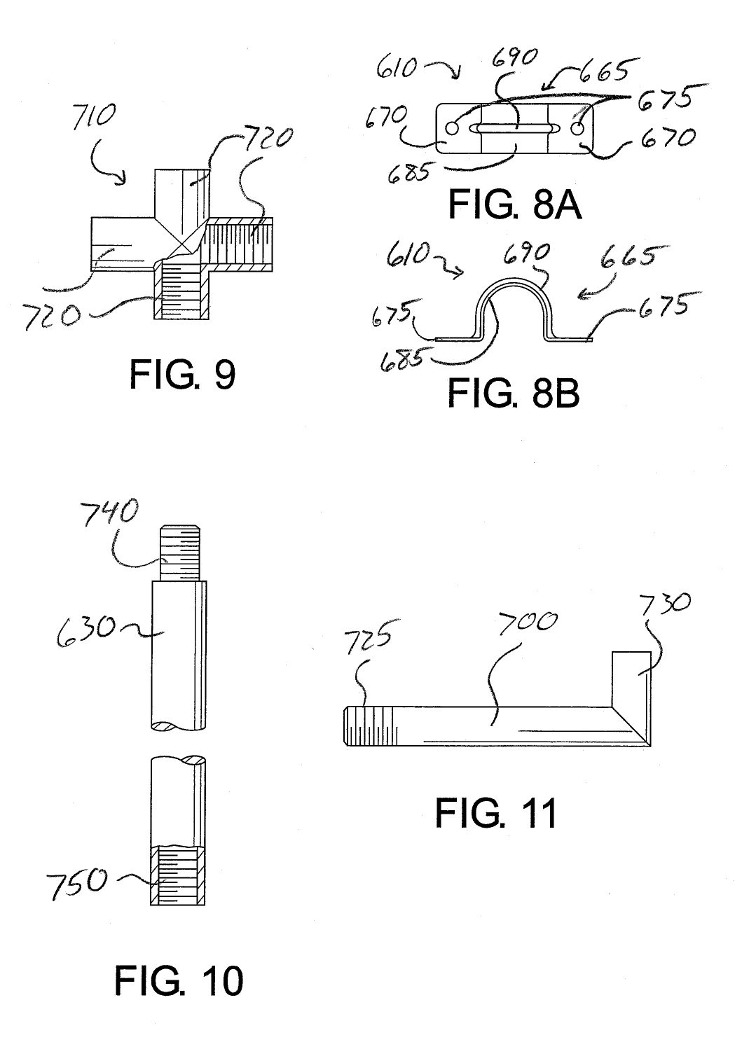

In one embodiment, the brackets are attached to the tree with conventional fasteners 660 such as a nail or screw. Each bracket is generally elongated and is positioned along the tree in a generally transverse orientation relative to the elongated pole assembly 680. As shown in FIGS. 8A and 8B, the bracket 610 includes an elongated body 665 having a pair of flange portions 670 located on opposed ends of a central U-shaped portion 685. Each flange portion 670 includes an aperture 675 to receive the fastener 660 therein. The U-shaped portion 685 supports the elongated pole assembly 680 in moving arrangement with the tree. In one embodiment, a structural ridge 690 is placed along the U-shaped portion 685 to provide additional stability to the body 665 of the bracket 610.

With reference now also to FIG. 11, the tree roper device 600 includes a rest bar 700 that is attached to the elongated pole assembly 680 at a top portion 705. The rest bar 700 extends radially from the elongated pole assembly 680 to allow for selective support of a tension line such as line 440. In one embodiment, the rest bar 700 is attached to a T-connector 710 that is connected to the elongated pole assembly 680. With reference now to FIG. 9, the T-connector 710 includes a plurality of ports 720 to receive and support the rest bar 700 and the segment extensions 630. In FIG. 9, the T-connector 710 includes four (4) cylindrically shaped threaded ports or openings 720 that are equally spaced apart to support at least one cylindrically shaped rest bar 700 in a generally perpendicular orientation relative to the segment extensions 630. The T-connector 710 is configured to receive a threaded end 725 (see FIG. 11) of the rest bar 700 for selective engagement therein. Notably, the rest bar 700 also includes an upturned distal portion 730 to support the tension line 440 thereon. In FIG. 10, at least one segment extension 630 is shown to be elongated and generally cylindrically shaped having a threaded male end 740 and an oppositely disposed threaded female end 750. The male end 740 of each segment 630 is configured to be received by a similarly shaped female end 750 of an adjacent segment. The elongated pole assembly 680 is adapted to extend longitudinally along the tree with the coupling of additional segment extensions 630. The threaded ends of each element of the device 600 allows for manual assembly, disassembly, compact storage and ease of transport thereof. Additionally, it allows the user to selectively assembly the device adjacent to the tree.

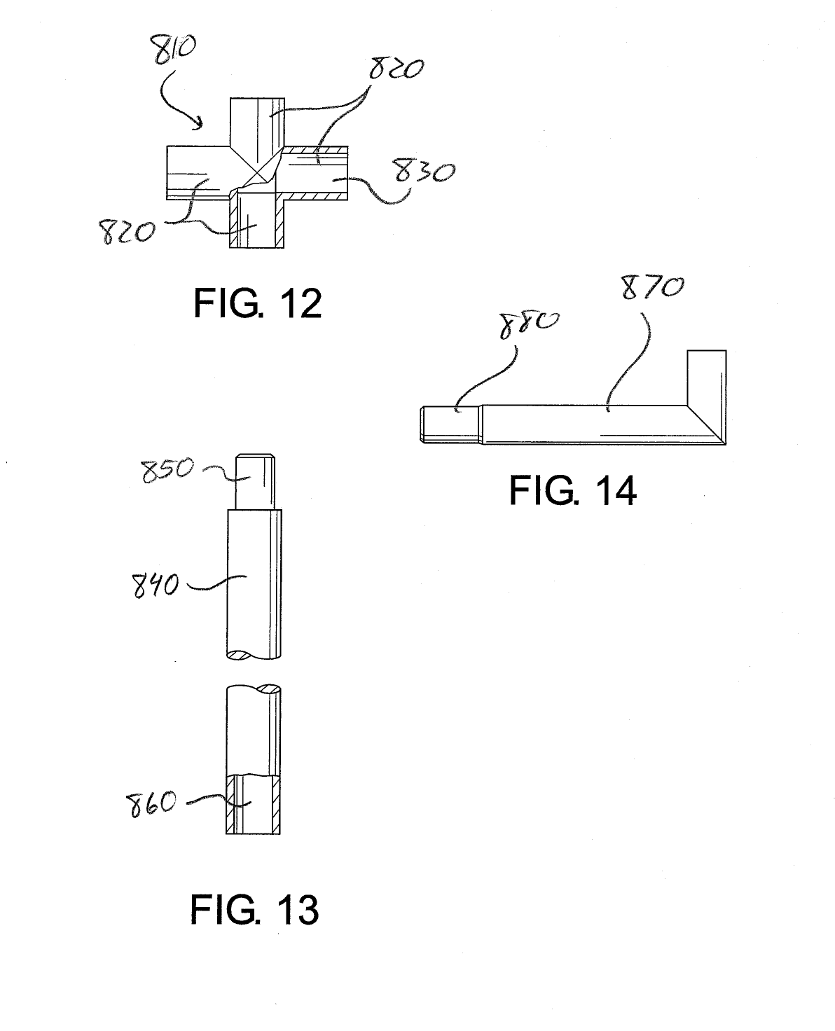

In one embodiment as illustrated by FIG. 12, the T-connector 810 includes a plurality of ports or openings 820 having a smooth inner surface 830 adapted to receive similarly configured smooth male ends. In this embodiment, the segment extension 840 includes a smooth male end 850 and a smooth female end 860 (see FIG. 13). Similarly, in FIG. 14, the rest bar 870 includes a smooth male end 880 adapted to fit within the ports 820. It is intended that a friction fit be achieved with the several connector elements being joined to each other. The smooth ends of each feature of the device 600 allows for easy disassembly, compact storage and transport of the components. Additionally, it allows the user to selectively assemble the device in close proximity to the tree.

Turning again to FIG. 7, the tree roper device 600 is secured to the tree with two to four brackets. The brackets 610, 620 keep the plurality of connected segments 630 from swaying and falling as the segments 630 are attached to one another. In one embodiment, the first bracket 610 can be placed about 6 feet from the ground and the subsequent two or three brackets can be placed at about 1 or 2 foot increments higher than the first bracket 610 if so desired.

The rest arm 700 functions to support the tension line 440 and the attached weight 450 thereon. Additionally, the rest arm 700 can be rested on branches of the tree as the elongated pole assembly 680 is being lifted towards the designated height.

In one method to secure the tension line to the desired portion of the tree, the user first identifies the location of the branch or portion of the tree that is to receive the tension line 440. The user then locates the clearest path of travel along the tree for the elongated pole assembly 680. At least one bracket is attached to the tree to secure the tree roper device 600 thereon. The T-connector 710 and rest arm 700 are attached to a first segment 630. The first segment is fed downward through the brackets 610, 620. The line 440 and weight 450 are positioned over the rest bar 700. Additional segment extensions 630 are connected to the first segment thereby raising the rest bar 700 upward towards the desired portion of the tree. Once the rest arm 700 is at the desired height, the elongated pole assembly 680 is rotated so that the rest arm 700, a portion of the tension line 440 and the weight 450 are positioned over the desired branch. The tension line 440 is released by the user and the weight 450 is lowered by gravity around the desired branch. Once the weight 450 is on the ground, the segments and brackets can be removed from the tree.

Similarly, the device 100, 600 can be used to position the tension line 440 around a desired portion of a tree without interfering branches. In this method, the rest bar 280, 700 and line 440 are raised to the desired position. A halfway portion of the line is positioned on the rest bar. Opposing ends of the tension line 440 are positioned around the tree at an opposite side from the location of the device 100, 600. The ends of the tension line 440 are pulled by a user until the line 440 is not supported by the rest bar and is snuggly positioned around the tree. The line 440 remains under the control of the user and kept in tension around the desired position of the tree. The opposing ends of the tension line 440 can be held in place by the user or braced by an associated object to maintain tension or frictional engagement of the line 440 around the desired position of the tree. The segments and brackets can then be removed from the tree. In this embodiment, the weight 450 is not required.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A tree roper device for placement of a line about a designated portion of an associated tree, the tree roper device comprising:
an elongated pole assembly having a first end and a second end;
at least one pole bracket configured to attach to the associated tree and operably connected to the elongated pole assembly such that the elongated pole assembly is movable relative to the associated tree;
a rest bar attached to the elongated pole assembly adjacent the second end thereof; and
a line having a line length with a first, proximal end and a second, distal end operably attached to a weight, the line being selectively supported on the rest bar such that movement of the elongated pole assembly positions the line and the weight in a predetermined position relative to the associated tree.

2. The tree roper device according to claim 1, wherein the elongated pole assembly comprises a plurality of segments operably connected to one another such that a distance between the first end and the second end is increased by connecting additional segments.

3. The tree roper device according to claim 1, wherein a first pole bracket is attached to the associated tree at a first location and a second pole bracket is attached to the associated tree at a second, spaced, location such that the second location is generally aligned with the first location along the associated tree to support the elongated pole assembly at the first and second locations and allow the elongated pole assembly to translate and rotate in relation to the associated tree.

4. The tree roper device according to claim 1, wherein the pole bracket comprises an elongated body configured for selective attachment to the associated tree.

5. The tree roper device according to claim 3, further comprising a frame support assembly which connects the first pole bracket to the second pole bracket.

6. The tree roper device according to claim 5, wherein the frame support assembly includes a first axis offset from a second axis, the first axis being aligned with the first pole bracket and the second pole bracket, the second axis being aligned with the elongated pole assembly.

7. The tree roper device according to claim 6, wherein the elongated pole assembly is operable to be rotated about at least one of the first axis and the second axis.

8. The tree roper device according to claim 7, wherein the first axis is parallel to the second axis.

9. The tree roper device according to claim 5, wherein the frame support member includes a first elongated section attached to a second elongated section.

10. The tree roper device according to claim 9, wherein the first elongated section and the second elongated section are segmented.

11. The tree roper device according to claim 9, wherein the elongated pole assembly is operably supported by the second elongated section.

12. The tree roper device according to claim 11, wherein the second elongated section is generally parallel to the first elongated section.

13. The tree roper device according to claim 1, wherein the rest bar assembly comprises at least one arm member extending from the elongated pole assembly to support the line.

14. The tree roper device according to claim 13, wherein the rest bar assembly comprises a T-connector with at least two spaced segments operable to attach to the elongated pole assembly and the arm member.

15. A system for assisting placement of a line about a portion of an associated tree with a tree roper device comprising:
an elongated pole assembly having a first end and a second end such that the first end is operative to be manipulated by an associated user to move the second end relative to the associated tree;
a first pole bracket selectively attached to the associated tree at a first height and a second pole bracket selectively attached to the associated tree at a second height such that the second height is greater than the first height, wherein the first and second pole brackets are generally aligned along a first axis to support the elongated pole assembly and allow the elongated pole assembly to translate and rotate about the first axis in relation to the associated tree;
a rest bar attached to the elongated pole assembly adjacent the second end; and
a line operably attached to a weight, the line being supported on the rest bar such that movement of the elongated pole assembly positions the line and the weight in a predetermined position relative to the associate tree.

16. The system according to claim 15, wherein the elongated pole assembly comprises a plurality of segments such that the pole assembly is extended to the predetermined height by connecting additional segments to the pole assembly.

17. A method of positioning a line over a branch of a tree, the method comprising the steps of:
securing a tree roper device including an elongated pole assembly, a frame support member, and a rest bar to the tree with a plurality of brackets;
lifting a distal end of the tree roper device towards the branch of the tree, the tree roper device supporting a line attached to a weight;
moving the distal end of the tree roper device over the branch to position the weight about the designated portion of the tree; and
lowering the weight from the elevated position about the branch thereby looping the line over the branch.

18. The method according to claim 17, wherein the elongated pole assembly is extended to a predetermined height relative to the associated tree.

19. The method according to claim 18, wherein the elongated pole assembly is rotated about at least one of a first axis and a second axis to position the rest bar assembly about the designated portion of the associated tree at the predetermined height.

20. The method according to claim 17, wherein the weight is lowered to secure the line to the portion of the associated tree at a predetermined height.
